(19) United States
(12) Patent Application Publication
(10) Pub. No.: US 2022/0241830 A1
(43) Pub. Date: Aug. 4, 2022

(54) TREATMENT OF CONTAMINATED SOIL AND WATER

(71) Applicant: ALPHA CLEANTEC AG, Zug (CH)

(72) Inventors: Uri Stoin, Jerusalem (IL); Yoel Sasson, Tel Aviv (IL); Alex Mojon, Uettligen (CH)

(21) Appl. No.: 17/761,315

(22) PCT Filed: Sep. 17, 2020
(86) PCT No.: PCT/IB2020/058675

§ 371 Date: Mar. 17, 2022

Related U.S. Application Data
(60) Provisional application No. 62/901,819, filed on Sep. 18, 2019.

(51) Int. Cl. B09C 1/08; B09C 1/00; C02F 1/72; C02F 1/74; C02F 1/66

(52) U.S. Cl. CPC B09C 1/08; B09C 1/002; C02F 1/722; C02F 2103/06; C02F 1/74; C02F 1/66; B09C 2101/00; C02F 1/727

(57) ABSTRACT

A method of remediation of polluted soil or water by chemical oxidation of organic pollutants, including adding to the soil or water separate or joined streams of aqueous iron salt solution and an acid, and injecting aqueous hydrogen peroxide solution and oxygen-containing gas to the soil or water, such that said aqueous streams and the oxygen-containing gas mix with one another in the soil or water in an acidic environment.

### CROSS-REFERENCE TO RELATED APPLICATION

This application is a National Stage application of International Patent Application No. PCT/IB2020/058675, filed on Sep. 17, 2020, which claims priority to U.S Application No. 62/901,819 filed on Sep. 18, 2019, each of which is hereby incorporated by reference in its entirety.

### TECHNICAL FIELD

The present invention relates to chemical oxidation method for decontamination of polluted soil and water (e.g., groundwater).

### BACKGROUND

The contamination of soil and groundwater by organic chemicals remains a significant world-wide problem, even after decades of research. Land contamination is frequently driven by human activities such as inadequate intensive agriculture, construction works, industrial and military activities, etc. The most common soil pollutants are: polychlorinated hydrocarbons (PCHs), polycyclic aromatic hydrocarbons (PAHs), polychlorinated biphenyls (PCBs), chlorinated solvents, petroleum products and pharmaceutical leftovers. The contamination of soils, groundwater and sediments by persistent organic pollutants (POPs) such as PAHs, PCBs, PCHs and petroleum products constitutes an environmental concern because of their high chronic toxicity to both animals and humans, and their long-lasting sorption by soils and sediments.

Solutions for soil decontamination fall into two major categories: 1) ex situ technologies, which include excavating soils, followed by treatment of the excavated soil either on site or away from the polluted site in a special facility, and land filing, and 2) in situ technologies which include chemical treatment such as chemical oxidation, photocatalysis and/or electrochemical treatment. Each approach has its advantages and disadvantages; there exists a need for an efficient methodology that could be easily adapted to either ex-situ, in-situ and on-site operations.

Groundwater remediation can be divided in a way similar to that described in the immediately preceding paragraph: 1) “pump and treat” technologies, where water is pumped up from the reservoir to above-ground reactor, where the water is treated to remove the pollutants, e.g., by chemical treatment, and returned to the underground source, and 2) in situ technologies that include deep pressure injection (ISCO—in situ chemical oxidation) of chemical oxidants to groundwater.

Commercial example is RemOX

(https://www.carusllc.com/remediation/products/remox-s-isco-
reagents#:~:text=RemOx%C2%AE%20S%2DB%20ISCO%
20reagent,fracturing%20low%20permeability%20areas.)

The approach based on chemical oxidation could fit into both ex-situ and in-situ soil and groundwater remediation methods. Chemical oxidation for in-situ soil and groundwater remediation involves injecting the oxidizer into the soil (or groundwater) to decompose the contaminant in place. Various oxidizers were considered for soil and/or groundwater decontamination, such as hydrogen peroxide (see U.S. Pat. No. 5,286,141), Fenton reagent (consisting of a mixture of hydrogen peroxide and ferrous salt in an acidic environment—see for example U.S. Pat. No. 5,286,141), permanganate (see U.S. Pat. No. 6,315,494), and a combination of hydrogen peroxide and aqueous alkali hydroxide (see U.S. Pat. No. 9,956,597).

### SUMMARY

We have now found that soil and water (e.g., groundwater) remediation methods based on addition of the Fenton reagent to the soil or water could be modified to destroy (or at least significantly reduce the concentration level of) hydrocarbon pollutants, especially persistent organic pollutants, to achieve extensive purification of the soil and water, respectively. In the conventional Fenton reaction, hydrogen peroxide reacts with ferrous ion according to the following chemical equation (1):

H₂O₂+Fe²⁺→OH⁻+OH⁻+Fe³⁻ (1)

The hydroxyl radical (OH′) generated by the Fenton reaction is a very strong oxidizer, accounting for the ability of the Fenton reagent to decompose organic contaminants.

Experimental work conducted in support of this invention shows that moving air/oxygen through contaminated soil that is soaked with an aqueous Fenton reagent, or bubbling air/oxygen through polluted water sample to which the Fenton reagent was added, enhances the oxidation of the organic contaminants, apparently owing to generation of new oxidant species.

Without wishing to be bound by theory, a reaction mechanism is illustrated in FIG. 1. The invention could also benefit from the addition of a base, e.g., addition of alkali hydroxide after some delay, namely, after the Fenton reaction has advanced for some time, then a base and H₂O₂ are added, with continued injection of air/oxygen.

The method for soil and water (e.g., groundwater) remediation according to the invention starts with the creation of the conditions for the Fenton reaction. That is, the Fenton reaction is initiated by addition of hydrogen peroxide to aqueous ferrous salt solution-soaked soil under acidic environment, or to polluted water (e.g., groundwater), to which the ferrous salt and acid were added. However, the reaction is conducted under aeration of the treated soil/groundwater, namely, injection of oxygen-containing gas stream (air or neat oxygen) into the soil/groundwater. The non-balanced chemical equation of the oxidation reaction of the organic pollutants is shown below (CH stands for the oxidizable organic material):

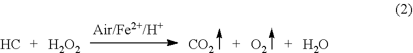

The ‘oxygen-augmented Fenton-like reaction’ of equation (2) is allowed to continue for some time and then alkali hydroxide solution is added to the soil/groundwater, which is treated under the newly-created alkaline environment for an additional period of time. H₂O₂ is simultaneously added with the alkali hydroxide. Experimental results reported below indicate that persistent organic pollutants in soil/groundwater are almost completely destroyed with the aid of the method of the invention.

Accordingly, the invention is primarily directed to a method of remediation of polluted soil or water (e.g. groundwater) by chemical oxidation of organic pollutants, comprising adding to the soil or water separate or joined streams of aqueous iron salt solution and an acid, and injecting aqueous hydrogen peroxide solution and oxygen-containing gas to the soil or water, such that said aqueous streams and the oxygen-containing gas mix with one another in the soil or water in an acidic environment.

To achieve effective soil remediation, the ‘oxygen-augmented Fenton-like reaction’ takes place in polluted soil, upon mixing hydrogen peroxide solution with an aqueous ferrous salt solution-soaked soil, under acidic conditions. That is, separate or joined Fe²⁺ and H⁺ streams are first delivered so as to infiltrate the soil, to establish acidic environment, and then H₂O₂ solution is mixed with the wetted soil, with air moving through the soil. For example, one variant of the invention comprises successively adding to the soil a first aqueous stream that contains ferrous salt and a mineral acid and a second aqueous stream of hydrogen peroxide, wherein the injection of the oxygen-containing gas to the soil starts simultaneously with, or after, the addition of the hydrogen peroxide stream. Decontamination, i.e., oxidation of organic pollutants due to the ‘oxygen-augmented Fenton-like reaction’ proceeds in an acidic environment over a period of time, before the pH is adjusted to the alkaline range to generate a secondary decontamination effect, described below.

Effective groundwater remediation follows similar approach, but the supply of Fe²⁺, H⁺ and H₂O₂ aqueous streams and aeration of the polluted groundwater (bubbling air/oxygen therethrough) take place essentially simultaneously, or just a short time after the addition of the Fe′ and the acid, because acidification is achieved rapidly. For example, once pH drop is detected in the polluted groundwater as described below, the feed of H₂O₂ and air/oxygen could begin.

For example, the hydrogen peroxide solution utilized has a concentration of between about 5 to about 55 wt %, e.g., 35%. The ferrous salt used for the reaction is preferably a water-soluble ferrous salt selected from, but not limited to, the group consisting of ferrous sulfate, FeCl₂ and Fe(NO₃)₂. The ferrous salt is added in the form of an aqueous solution with concentration ranging from 1 wt % and 30 wt %. The aqueous ferrous salt solution further comprises an acid, e.g., a mineral acid, to allow the favorable acidic conditions of the reaction. A mineral acid utilized is selected from the group consisting of sulfuric acid, nitric acid, hydrochloric acid and mixtures thereof. In some further embodiments, the mineral acid concentration in the ferrous salt solution is about 0.1 mM to about 1M, setting the pH in the treated location in the reaction medium (i.e., soil or groundwater) at about 1 to 5-6. But the ferrous and acid solutions can be supplied to the soil by two separate streams.

In the ‘oxygen-augmented Fenton-like reaction’ of the invention, oxygen is supplied to the reaction such that the molar concentration of oxygen is preferably not less than 1% relative to hydrogen peroxide, e.g., from 1 to 10% relative to hydrogen peroxide, for example, from 1 to 5 molar %.

In a preferred embodiment of the present invention, the Fenton reaction proceeds for some time, followed by the addition of an alkaline solution, e.g., alkali hydroxide solution, into the soil or groundwater. The alkali hydroxide utilized may be KOH or NaOH etc., with concentration ranging between about 0.5 and 48 wt %. That is, the base solution is added after the progression of the air-augmented Fenton reaction for a period of time, say, after 0.5 and 3 hours have lapsed. Post-treatment pH reached by the method of the invention is usually above 8, e. g., from 8.5 to 10 (pH is restored to normal—nearly neutral—values following rainwater).

### BRIEF DESCRIPTION OF THE DRAWINGS

The method of the invention fits well into ex situ, on site and in situ applications for soil and water (e.g., groundwater) treatments and these modes of operation shall now be described in reference to the drawings:

treatment of excavated soil on site (FIG. 2);
treatment of polluted soil in-situ, i.e., destroying pollutants in place (FIG. 3);
treatment of water (e.g., groundwater) by the ‘pump and treat’ method (FIG. 11); in-situ chemical oxidation of groundwater by injecting reagents to the groundwater (FIG. 12).

FIG. 2 illustrates one preferred apparatus for carrying out treatment of excavated soil on site. The reagents used in the method, namely, the acidic solution, the ferrous salt (e.g., in a solid form), aqueous hydrogen peroxide and the alkaline solution are separately held in tanks 1, 2, 3 and 4, respectively. Soil decontamination takes place in a reactor 7 equipped with powerful agitators. Reactor 7 may be configured as a revolving drum or other mixer design commonly used in concrete mixing devices. In operation, the acidic solution is fed to vessel 6 with the aid of a pump 12. Vessel 6 is provided with a suitable stirring element to enable rapid dissolution of the solid ferrous salt that is added to vessel 6, forming acidic ferrous solution that is led to reactor 7 via feed line driven by pump 8. Addition of the solid ferrous salt can be done with a solid dosing pump to supply metered amounts of the ferrous salt. Another feed line is provided, to enable direct flow of the acidic solution per se to reactor 7 through pump 11. Contaminated soil is charged to reactor 7 where it is vigorously mixed with the acidic solution to create the acidic environment required for advancing the Fenton reaction. Next, aqueous hydrogen peroxide stream is pumped 9 from tank 3 and introduced into reactor 7 whereby the Fenton reaction starts.

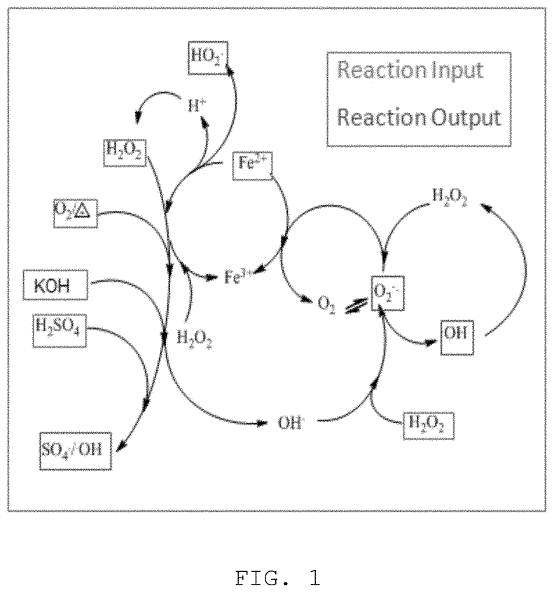

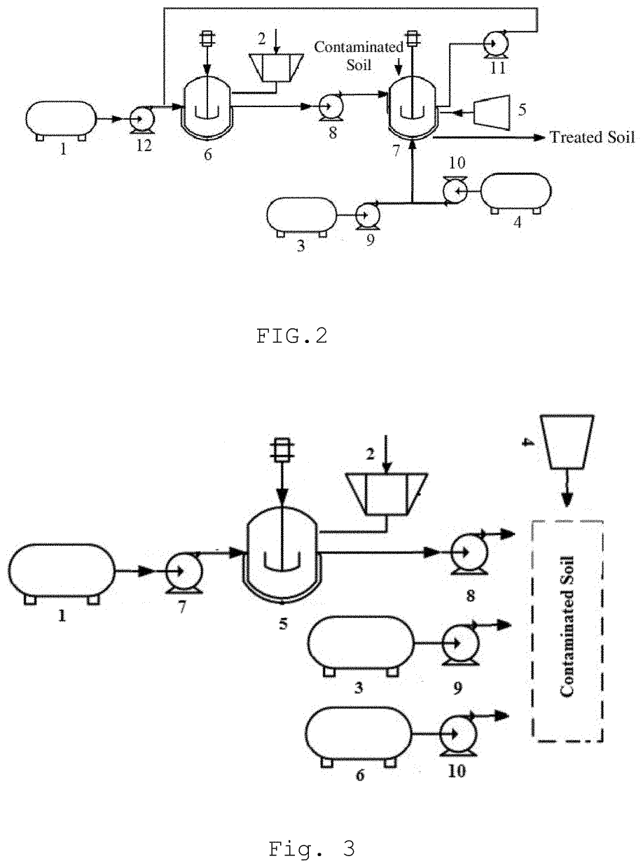

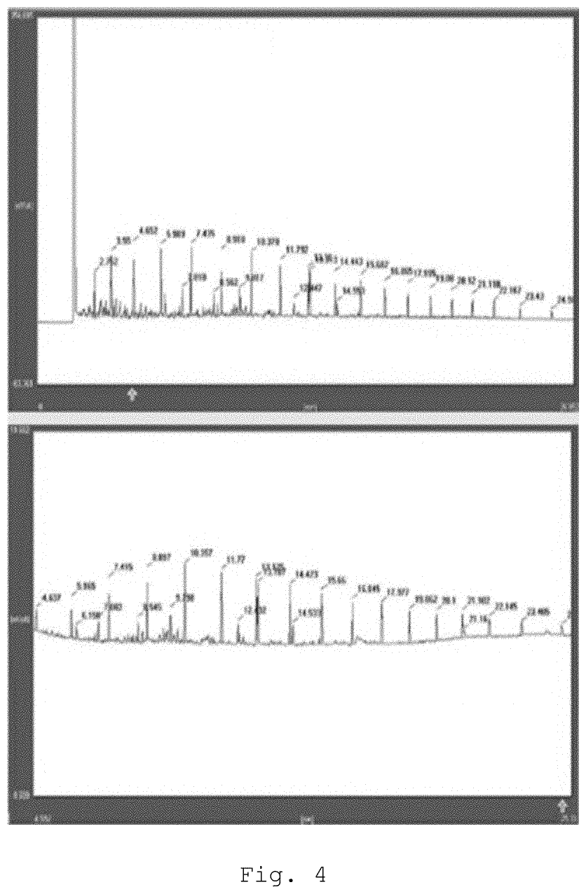

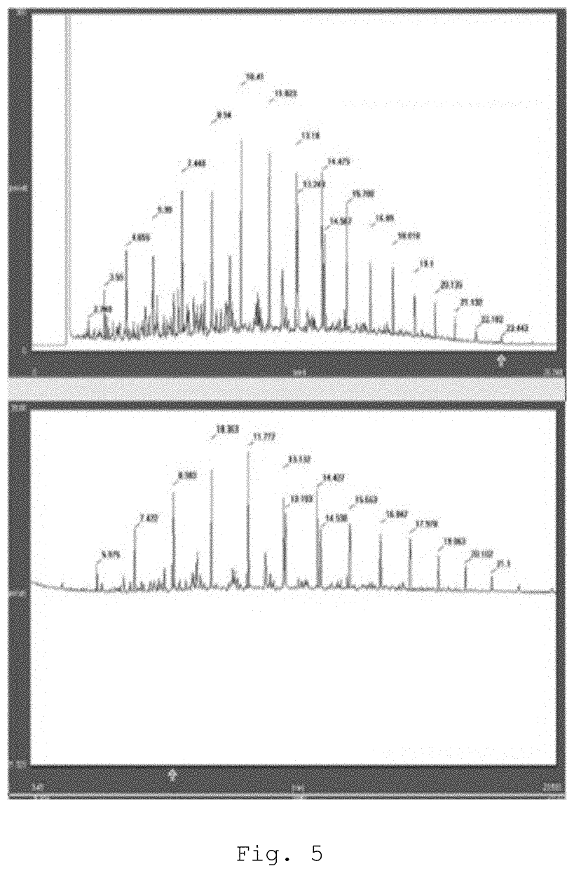

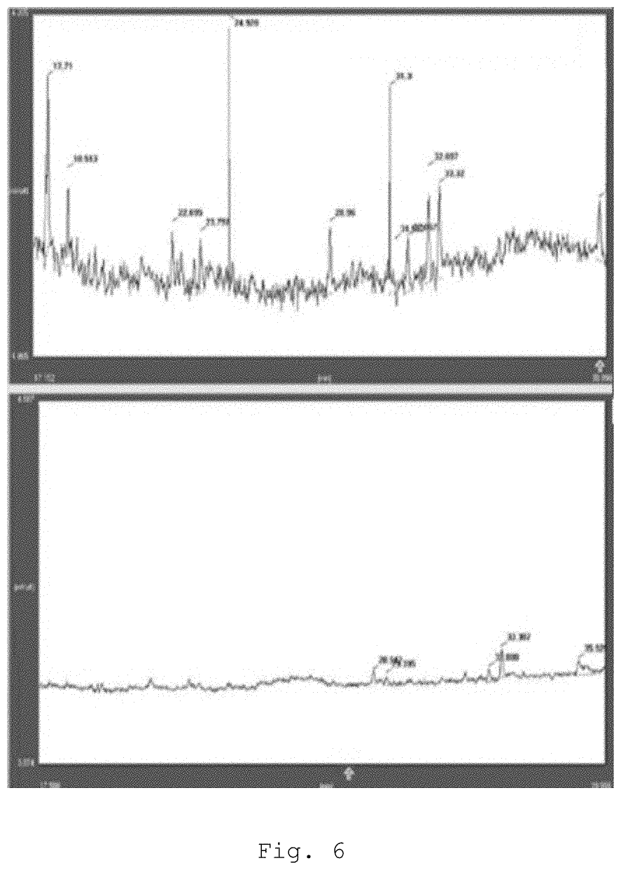

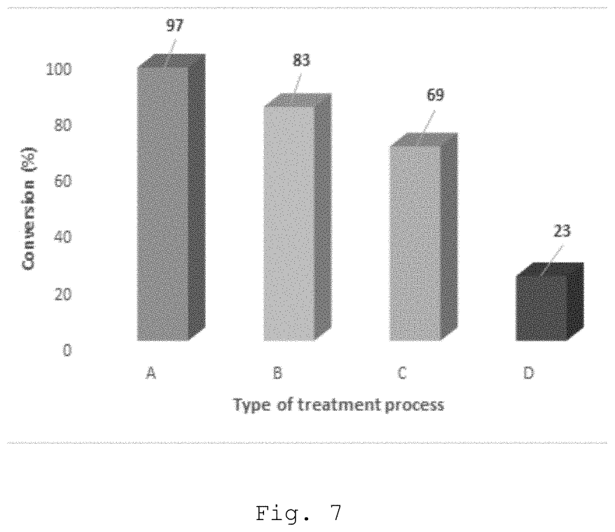

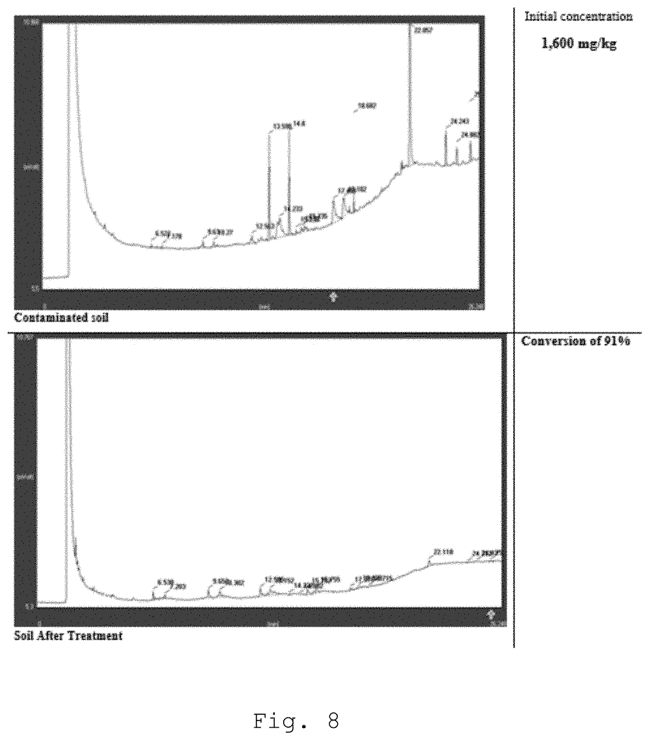

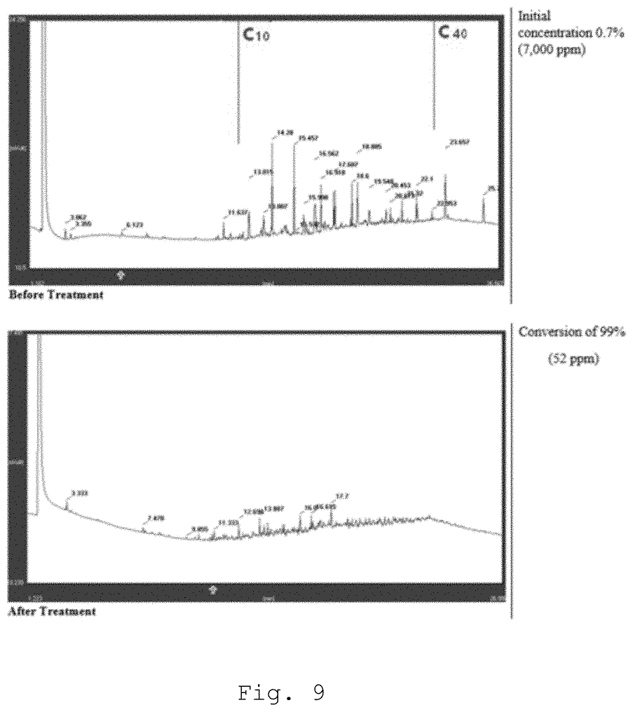

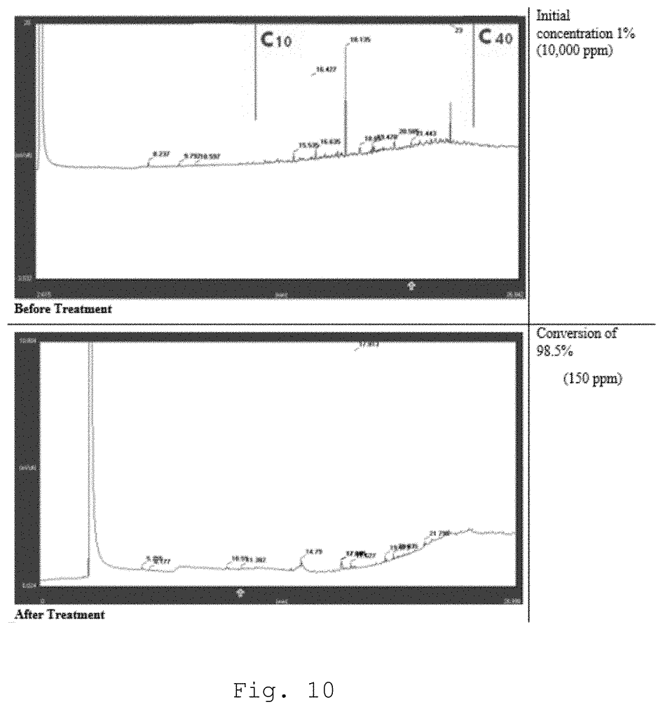

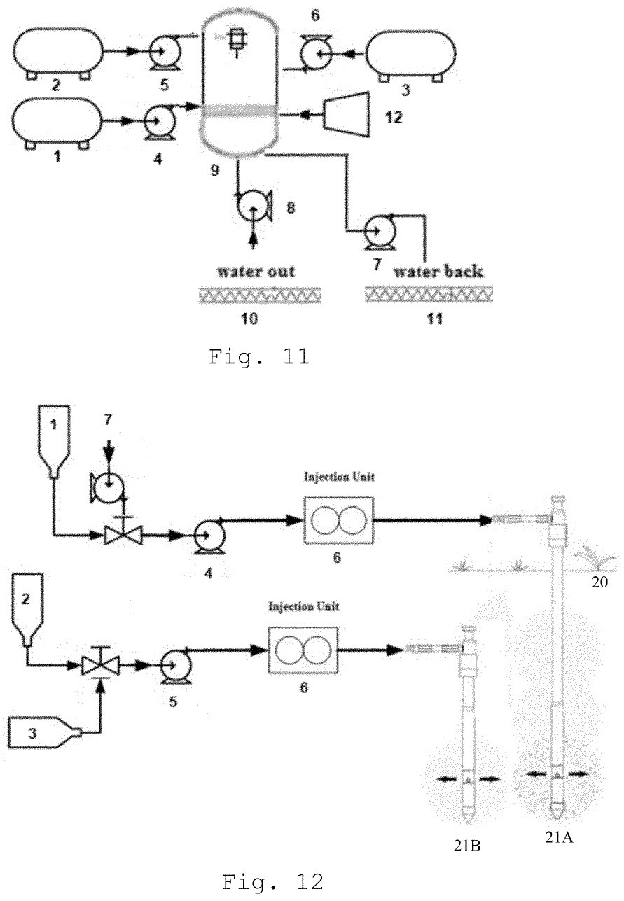

Aeration is provided by air pump 5, pushing air to the agitated soil. Suitable pumps operate at throughput of 1 ml/min to 1,000 ml/min; the air moves through the soil that is wetted by the aqueous streams, greatly improving the decontamination effect of the Fenton reagent as previously explained. For example, in the apparatus shown in FIG. 2, a batch size of 0.1-2 m³ contaminated soil polluted with about 0.1-100,000 ppm of organic pollutants may be treated with a volume of 60-1,200 liter of acidic ferrous salt and 20-600 liter of aqueous hydrogen peroxide with the concentrations mentioned above to achieve an effective removal of the pollutants within 0.5-8 hours under constant air/oxygen supply of 1 L/min to 1,000 L/min, with further addition of 20-600 liter of sodium hydroxide solution.

Turning now to an in-situ soil remediation for destroying the pollutants in place, in its simplest form it is accomplished with the aid of portable soil injectors operated manually by one or more workers in order to purify local contamination in the field, utilizing both liquid injectors and gas injectors to meet the requirements of the invention; i.e., using ISCO (In-situ chemical oxidation) injection systems. One possible arrangement is shown in FIG. 3 where the contaminated land is encircled by a dashed line. The reagents used in the process, namely, the acidic solution, the ferrous salt (e.g., in a solid form), aqueous hydrogen peroxide and the alkaline solution are separately held in tanks 1, 2, 3 and 6, respectively. High pressure pumps are used to drive the aqueous streams and inject them directly into the soil are indicated by numerals 8, 9 and 10. Air pump 4 pushes air that moves and disperse in the soil. As already pointed out in reference to FIG. 2, the ferrous salt is preferably combined with the acidic solution in advance, by mixing these two components in vessel 5, e.g., the acidic stream is led by pump 7 to vessel 5 where the solid salt is dissolved and the so-formed joined stream is supplied to the ground, followed by the injection of the hydrogen peroxide stream to the wetted soil. The aeration of the soil is accomplished by injecting air/oxygen stream into the soil sought to be treated. Manually operated soil injectors could also be used, by a moving trailer that carries tanks holding the reagents and a suitable air pump. The injection of air/oxygen into the soil occurs during the injection of both ferrous salt solution and hydrogen peroxide solution. In another embodiment, the aeration takes place during the injection of ferrous salt solution or the hydrogen peroxide solution or after it. On a laboratory scale, air is injected to the treated soil sample at a flow rate of 0.1 ml/min to 1000 ml/min. On an industrial scale, flow rates from 1 L/min to 1000 L/min are contemplated.

As an alternative to the arrangement shown in FIG. 3, three arrays of conduits can be assembled in the site to be treated, one to convey and distribute the aqueous acidic ferrous salt solution, another to deliver the H₂O₂ stream, and one for enabling the aeration of the treated soil during the reaction by distributing air/oxygen gas. Each array consists of a plurality of horizontally aligned conduits 0.5-10 cm in diameter extending above the ground with a set of evenly spaced pipes extending vertically and downwardly from the horizontal conduits beneath the level of the ground, e.g., at a depth of about 100 to 600 cm. The arrays of conduits are mounted in parallel to allow the flow of the fluids and enable them to react with one another as close as possible to the contaminant distributed in the field.

Turning now to groundwater remediation, FIG. 11 illustrates integration of chemical oxidation based on the ‘oxygen-augmented Fenton-like reaction’ into a conventional ‘pump and treat’ technology. An acidic solution of the ferrous salt, aqueous hydrogen peroxide and an alkaline solution are held in tanks 1, 2 and 3, respectively. Pumps 4, 5 and 6, respectively, supply the reagents to reactor 9, where the chemical oxidation takes place. In the configuration illustrated, a joined stream of Fe/H⁺ is used, but the ferrous salt and acid can be fed separately to the reaction.

In operation, a predetermined volume of water is pumped up by pump 8 from groundwater reservoir 10 into above-ground reactor 9. A metered amount of the Fe/H⁺ solution is fed to the reactor and mixed with the polluted groundwater to create an acidic environment, e.g., pH in the range from 2 to 6. Because an acidic pH is established almost instantaneously in reactor 9, the Fe/H⁺ solution 1 and aqueous hydrogen peroxide solution 2 are fed essentially concurrently to the reactor, or with just a short delay between the two. For example, the pH of the reaction medium in reactor 9 may be monitored and once a preset pH drop is indicated, then aqueous hydrogen peroxide solution 2 is pumped from tank 2 and introduced into reactor 9 to initiate the Fenton reaction, with intensive bubbling of air through the treated water occurring simultaneously, supplied to the reactor by air pump 12. Suitable air pumps operate at throughput of 10 ml/min to 1000 ml/min. The treatment continues for 30 to 240 minutes. Next, alkali hydroxide 3 is added to the reactor (H₂O₂ addition continues, i.e., MOH and H₂O₂ are both supplied at this stage, with injection of air to the groundwater), and the reaction mixture is maintained under stirring for 30 to 240 minutes. At the end of the treatment (post-treatment pH is usually from 8 to 10), the treated water is discharged from reactor 9 and the outflowing water stream is reinjected by pump 7 to the groundwater source 11.

For example, in the apparatus shown in FIG. 11, a batch size of 1-10 m³ contaminated water polluted with about 1 ppb-10000 ppm of organic pollutants may be treated with a volume of 5-1000 liter of acidic ferrous salt and 20-2000 liter of aqueous hydrogen peroxide with the concentrations mentioned above, to achieve an effective removal of the pollutants within 0.5-4 hours under constant air/oxygen supply of 0.01 L/min to 1 L/min, with further addition of 0.1-10 liter of 48% by weight of sodium hydroxide solution.

Accordingly, the invention provides a method for water (e.g., groundwater) remediation, comprising the steps of:

pumping water (e.g., groundwater) to an above-ground reactor;
treating the water in the reactor by a two-stage chemical oxidization, wherein the first stage includes addition to the water of a ferrous salt, an acid, hydrogen peroxide with simultaneous injection of the oxygen-containing gas; and the second stage includes addition of alkali hydroxide and hydrogen peroxide with simultaneous injection of the oxygen-containing gas, to reach, e.g., a post-treatment pH above 8; and
discharging the treated water from the reactor and reinjecting the treated water to the water source (e.g., groundwater).

Another approach, based on direct treatment of groundwater, is schematically illustrated in FIG. 12. The reagents are injected to the groundwater to react in situ with the organic contaminants, using conventional ISCO (in-situ chemical oxidation) technologies. For example, the reagents are supplied through a plurality of injection wells extending into the groundwater. In FIG. 12, the ground surface is indicated by numeral 20. A pair of injection wells are shown 21A, 21B, extending downward into the groundwater source (not shown). The structure of the injection wells is conventional, and therefore is not shown in detail. For example, details of an injection well are seen in FIG. 3 of U.S. Pat. No. 5,286,141. The injections wells are spaced apart from one another; the exact distance depends on various factors, e.g. geological factors etc. Pairs of injection wells such as 21A, 21B may be positioned on several locations across the groundwater reservoir.

Hydrogen peroxide solution, acidic solution of ferrous salt, and alkali hydroxide solution are separately held in supply tanks 1, 2 and 3, respectively. High pressure pumps used to inject the solutions directly into the groundwater are indicated by numerals 4 and 5. Injection unit 6 are commercially available, such as Geoprobe Model 540MT Soil Probe Unit. Air pump 7 pushes air that moves and disperse in the groundwater. In the setup shown in FIG. 12, H₂O₂ and the air are delivered to the groundwater via the same injection well, 21A. Fe/H⁺ solution 2 and alkali solution 3 are supplied successively upon adjustment of the valve controlling the flow.

The invention is therefore also directed to a method for water (e.g., groundwater) remediation based on in-situ chemical oxidation, comprising the steps of:

introducing to the water (e.g., groundwater) a ferrous salt, an acid, hydrogen peroxide with simultaneous injection of an oxygen-containing gas; and
adding alkali hydroxide and hydrogen peroxide with simultaneous injection of the oxygen-containing gas, to reach, e.g., a post-treatment pH above 8.

The removal of one or more pollutants selected from the group consisting of polychlorinated hydrocarbons, polycyclic aromatic hydrocarbons, polychlorinated biphenyls, chlorinated solvents, pharmaceutical leftovers, petroleum products such as petroleum, gasoline, crude oil, diesel fuel, aviation fuel, jet fuel, kerosene, liquefied petroleum gases, petrochemical feedstocks and any mixture thereof, e.g., total petroleum hydrocarbons (TPH) could be achieved with the aid of the invention. Analysis by Gas Chromatography-Flame Ionization Detector (GC-FID) reported in the experimental section indicates more than 90% reduction of crude oil, diesel, polychlorinated biphenyl and TPH contamination levels when polluted soil was treated according to the invention; and more than 95% reduction of crude oil, diesel and chlorinated solvents contamination levels when polluted water samples were treated according to the invention.

### BRIEF DESCRIPTION OF THE DRAWINGS

FIG. 1 shows a proposed reaction mechanism for the ‘oxygen-augmented Fenton-like reaction’.

FIG. 2 illustrates ex situ chemical oxidation of excavated polluted soil based on ‘oxygen-augmented Fenton-like reaction’.

FIG. 3 illustrates in situ chemical oxidation of polluted soil, based on ‘oxygen-augmented Fenton-like reaction’.

FIGS. 4 and 5 show the results of GC-FID analysis for the experiment of Example 1 (soil treatment), demonstrating conversion of crude oil and diesel, respectively, achieved by the method of the invention (top section: polluted sample; lower section: treated sample).

FIG. 6 shows the results of GC-FID analysis for the experiment of Example 2 (soil treatment), demonstrating conversion of polychlorinated biphenyls, achieved by the method of the invention (top section: polluted sample; lower section: treated sample).

FIG. 7 is a bar diagram illustrating the results of a comparative study.

FIG. 8 shows the results of GC-FID analysis for the experiment of Example 4 (soil treatment), demonstrating conversion of TPH, achieved by the method of the invention (top section: polluted sample; lower section: treated sample).

FIG. 9 shows the results of GC-FID analysis for the experiment of Example 5 (water treatment), demonstrating conversion of crude oil and diesel, achieved by the method of the invention (top section: polluted sample; lower section: treated sample).

FIG. 10 shows the results of GC-FID analysis for the experiment of Example 6 (water treatment), demonstrating conversion of chlorinated solvents and diesel, achieved by the method of the invention (top section: polluted sample; lower section: treated sample).

FIG. 11 illustrates groundwater remediation by integration of the ‘oxygen-augmented Fenton-like reaction’ into ‘pump and treat’ technology.

FIG. 12 illustrates in situ chemical oxidation of groundwater based on the ‘oxygen-augmented Fenton-like reaction’.

### DETAILED DESCRIPTION

### Examples

### Example 1

### Soil Treatment—Removal of Crude Oil and Diesel

The experimental set-up consists of 1000 mL adiabatic glass reactor equipped with a magnetic stirrer and fitted with 100% oxygen cylinder, with flow rate of 1 ml/min or with 100% air cylinder (Maxima, LTD). The Purity level of the gas in both gas cylinders is 99%.

The reactor was charged with a soil sample (1 g) that was artificially contaminated with a mixture consisting of crude oil and diesel, to reach 1% (10,000 ppm) total contamination level. A volume of 0.7 mL of a separately prepared solution of ferrous sulfate heptahydrate and sulfuric acid (0.1 g of FeSO₄.7H₂O dissolved in 0.7 ml of water to which 0.2 μL of H₂SO₄ 98% was added) was fed to the glass beaker under stirring (100 rpm stirring velocity).

Thirty minutes elapsed before the addition of hydrogen peroxide began, during which period the aqueous ferrous solution was absorbed by the soil sample. Hydrogen peroxide (0.3 mL of 35% solution) was then added slowly to the reactor. The reaction proceeded for two hours under stirring and continuous aeration by means of injecting an air stream to the reactor at a flow rate of 1 ml/min.

The soil at the end of the process was extracted with 1 ml of toluene and measured by GC-FID (Thermo Ltd. RESTECK. FAMEWAX™ 30 m, 0.32 mm ID, 0.25 μm) as shown in FIGS. 4 and 5. The results indicate 92% and 90% conversion of the crude oil and diesel contaminants, respectively.

### Example 2

### Soil Treatment—Removal of Polychlorinated Biphenyls

An experimental set-up similar to that of previous example was used. The reactor was charged with a soil sample (1 g) that was taken from PCBs polluted site. The contamination level was estimated to be about 2 ppm. A volume of 0.7 mL of a separately prepared solution of ferrous sulfate heptahydrate and sulfuric acid (0.1 g of solid FeSO₄.7H₂O dissolved in 0.7 ml of water to which 0.2 μL of H₂SO₄ 98% was added) was fed to the glass beaker under stirring (100 rpm stirring velocity).

Thirty minutes elapsed before the addition of hydrogen peroxide began, during which period the aqueous ferrous solution was absorbed by the soil sample. Hydrogen peroxide (0.3 mL of 35% solution) was then added slowly to the reactor. The reaction proceeds for two hours under stirring and continuous aeration by means of injecting an air stream to the reactor at a flow rate of 1 ml/min.

Next, 0.1 mL of aqueous sodium hydroxide solution (1% by weight concentration) was added under the same continuous stirring, added H₂O₂ and aeration conditions described above over additional one hour.

The soil at the end of the process was extracted with 1 ml of toluene and measured by GC-FID (Thermo Ltd. RESTECK. FAMEWAX™ 30 m, 0.32 mm ID, 0.25 μm) as shown in FIG. 6. The results indicate 97% conversion of the PCBs pollutants that contaminated the soil sample.

### Example 3

### Soil Treatment—Removal of Polychlorinated Biphenyls Comparative Example

An experimental set-up similar to that of previous examples was used. Four different soil treatment were tested, in each of them the reactor was charged with a soil sample (1 g) that was taken from PCBs polluted site. The contamination level was estimated to be about 2 ppm.

The four different soil treatment procedures are detailed herein below:
A. The experimental conditions and reagent amounts were identical to those utilized in Example 2: A volume of 0.7 mL of a separately prepared solution of ferrous sulfate heptahydrate and sulfuric acid (0.1 g of solid FeSO₄.7H₂O dissolved in 0.7 ml of water to which 0.2 μL of H₂SO₄ 98% was added) was fed to the glass beaker under stirring (100 rpm stirring velocity). Thirty minutes elapsed before the addition of hydrogen peroxide began, during which period the aqueous ferrous solution was absorbed by the soil sample. Hydrogen peroxide (0.3 mL of 35% solution) was then added slowly to the reactor. Next, 0.1 mL of aqueous sodium hydroxide solution (1% by weight concentration) was added to the reactor over additional one hour. This process took place under constant stirring and continuous aeration by means of injecting an air stream to the reactor at a flow rate of 1 ml/min and added 14202.
B. The experimental conditions and reagent amounts were identical to those utilized in A, however, the process took place with no aeration, i.e. no air or oxygen injection into the reactor.
C. A volume of 0.7 mL of a separately prepared solution of ferrous sulfate heptahydrate and sulfuric acid (0.1 g of solid FeSO₄.7H₂O dissolved in 0.7 ml of water to which 0.2 μL of H₂SO₄ 98% was added) was fed to the glass beaker under stirring (100 rpm stirring velocity). Thirty minutes elapsed before the addition of hydrogen peroxide began, during which period the aqueous ferrous solution was absorbed by the soil sample. Hydrogen peroxide (0.3 mL of 35% solution) was then added slowly to the reactor. This process was done with no aeration, i.e. no air or oxygen injection into the reactor, and no addition of alkali hydroxide.
D. The conditions of the process were reproduced according to the publication Journal of Environmental Science and Health Part A (2009) 44, 1120-1126, in which 4.6 mL of hydrogen peroxide solution (35%) and 0.4 ml of the Fe₂(SO₄)₃ solution were reacted with 1 gr of soil, said comparative reaction took place for 4 hours.

The soil at the end of each process (A to D) was extracted with 1 mL of toluene and measured by GC-FID. The results are depicted in FIG. 7 in the form of a bar diagram; bars are indicated by the letters A-D, respectively. Clearly the method of the invention (A) emerges superior, achieving better decontamination effect, that is, practically almost full decontamination (expressed as conversion percentage; 97%, 83%, 69% and 23, for the A-D experiments, respectively).

### Example 4

### Soil Treatment—Removal of TPH

An experimental set-up similar to that of previous example was used. The reactor was charged with a soil sample (1 g) that was taken from TPHs polluted site. The contamination level was estimated to be about 1,600 ppm. A volume of 0.7 mL of a separately prepared solution of ferrous sulfate heptahydrate and sulfuric acid (0.1 g of solid FeSO₄.7H₂O dissolved in 0.7 ml of water to which 0.2 μL of H₂SO₄ 98% was added) was fed to the glass beaker under stirring (100 rpm stirring velocity).

Thirty minutes elapsed before the addition of hydrogen peroxide began, during which period the aqueous ferrous solution was absorbed by the soil sample. Hydrogen peroxide (0.3 mL of 35% solution) was then added slowly to the reactor. The reaction proceeds for two hours under stirring and continuous aeration by means of injecting an air stream to the reactor at a flow rate of 1 ml/min.

Next, 0.1 mL of aqueous sodium hydroxide solution (1% by weight concentration) was added under the same continuous stirring, added H₂O₂, and aeration conditions described above over additional one hour.

The soil at the end of the process was extracted with 1 ml of dichloromethane and measured by GC-FID (Thermo Ltd. RESTECK. FAMEWAX™ 30 m, 0.32 mm ID, 0.25 μm) as shown in FIG. 8. The results indicate 91% conversion of the TPHs pollutants that contaminated the soil sample.

### Example 5

### Groundwater/Wastewater Treatment—Removal of Crude Oil and Diesel

The experimental set-up consists of 2000 mL adiabatic glass reactor equipped with a magnetic stirrer and fitted with 100% oxygen cylinder, with flow rate of 0.5 ml/min or with 100% air cylinder (Maxima, LTD). The Purity level of the gas in both gas cylinders is 99%.

The reactor was charged with a contaminated water sample (500 mL) that was contaminated with a mixture consisting of crude oil and diesel, to reach 0.7% (7,000 ppm) total contamination level. A volume of 0.1 mL of a separately prepared solution of solid ferrous sulfate heptahydrate and sulfuric acid (0.1 g of FeSO₄.7H₂O dissolved in 0.1 ml of water to which 0.2 of H₂SO₄ 98% was added) was fed to the glass beaker under stirring (100 rpm stirring velocity).

Ten minutes elapsed before the addition of hydrogen peroxide began, during which period the aqueous ferrous solution was homogeneously dissolved in the sample. Hydrogen peroxide (0.3 mL of 35% solution) was then added slowly to the reactor. The reaction proceeds for four hours under stirring and continuous aeration by means of injecting an air stream to the reactor at a flow rate of 0.5 ml/min.

Next, 0.1 mL of aqueous sodium hydroxide solution (1% by weight concentration) was added under the same continuous stirring, added H₂O₂, and aeration conditions described above over additional one hour.

The water at the end of the process was extracted with 100 ml of dichloromethane and measured by GC-FID (Thermo Ltd. RESTECK. FAMEWAX™ 30 m, 0.32 mm ID, 0.25 μm) as shown in FIG. 9. The results indicate 99% conversion of the contaminated water.

### Example 6

### Groundwater/Wastewater Treatment—Removal of Chlorinated Solvents and Diesel

The experimental set-up consists of 2000 mL adiabatic glass reactor equipped with a magnetic stirrer and fitted with 100% oxygen cylinder, with flow rate of 0.5 ml/min or with 100% air cylinder (Maxima, LTD). The Purity level of the gas in both gas cylinders is 99%.

The reactor was charged with a contaminated water sample (500 mL) that was contaminated with a mixture consisting of chlorinated solvents and diesel, to reach 1% (10,000 ppm) total contamination level. A volume of 0.1 mL of a separately prepared solution of ferrous sulfate heptahydrate and sulfuric acid (0.1 g of FeSO₄.7H₂O dissolved in 0.1 ml of water to which 0.2 μL of H₂SO₄ 98% was added) is fed to the glass beaker under stirring (100 rpm stirring velocity).

Ten minutes elapsed before the addition of hydrogen peroxide began, during which period the aqueous ferrous solution was homogeneously dissolved in the sample. Hydrogen peroxide (0.3 mL of 35% solution) was then added slowly to the reactor. The reaction proceeds for four hours under stirring and continuous aeration by means of injecting an air stream to the reactor at a flow rate of 0.5 ml/min.

Next, 0.1 mL of aqueous sodium hydroxide solution (1% by weight concentration) was added under the same continuous stirring, added H₂O₂ and aeration conditions described above over additional one hour.

The water at the end of the process was extracted with 100 ml of dichloromethane and measured by GC-FID (Thermo Ltd. RESTECK. FAMEWAX™ 30 m, 0.32 mm ID, 0.25 μm) as shown in FIG. 10. The results indicate 98.5% conversion of the contaminated water.

While the present disclosure has been illustrated and described with respect to a particular embodiment thereof, it should be appreciated by those of ordinary skill in the art that various modifications to this disclosure may be made without departing from the spirit and scope of the present disclosure.

What is claimed is:

1. A method of remediation of polluted soil or water by chemical oxidation of organic pollutants, comprising adding to the soil or water separate or joined streams of aqueous iron salt solution and an acid, and injecting aqueous hydrogen peroxide solution and oxygen-containing gas to the soil or water, such that said aqueous streams and the oxygen-containing gas mix with one another in the soil or water in an acidic environment.

2. The method according to claim 1, comprising ex-situ, on site or in-situ chemical oxidation of polluted soil.

3. The method according to claim 2, comprising successively adding to the soil a first aqueous stream that contains ferrous salt and a mineral acid and a second aqueous stream which contains hydrogen peroxide.

4. The method according to claim 2, wherein the injection of the oxygen-containing gas to the soil starts simultaneously with, or after, the addition of the hydrogen peroxide stream.

5. The method according to claim 4, comprising addition of hydrogen peroxide to aqueous ferrous salt solution-soaked soil under acidic environment with injection of oxygen-containing gas stream into the soil, and allowing decontamination of pollutants to proceed under said acidic environment over a period of time.

6. The method according to claim 5, wherein a stream of aqueous alkali hydroxide solution is added to the soil after the lapse of said period of time, with addition of hydrogen peroxide and injection of oxygen-containing gas.

7. The method according to claim 2, wherein the soil is contaminated with one or more pollutants selected from the group consisting of polychlorinated hydrocarbons, polycyclic aromatic hydrocarbons, polychlorinated biphenyls, chlorinated solvents, pharmaceutical leftovers, petroleum products such as petroleum, gasoline, crude oil, diesel fuel, aviation fuel, jet fuel, kerosene, liquefied petroleum gases, petrochemical feedstocks and any mixture thereof.

8. The method according to claim 7, wherein the soil is contaminated with one or more of crude oil, diesel oil, polychlorinated biphenyls and TPH.

9. The method according to claim 1 for remediation of polluted water, comprising either the pumping of the polluted water and treatment by chemical oxidation; or in situ chemical oxidation of polluted water.

10. The method according to claim 9, comprising the steps of:
pumping groundwater to an above-ground reactor;
treating the water in the reactor by a two-stage chemical oxidization, wherein the first stage includes addition to the water of a ferrous salt, an acid, hydrogen peroxide with simultaneous injection of the oxygen-containing gas; and the second stage includes addition of alkali hydroxide and hydrogen peroxide with simultaneous injection of the oxygen-containing gas; and
discharging the treated water from the reactor and reinjecting the treated water to the groundwater.

11. The method according to claim 9, comprising the steps of:
introducing to groundwater a ferrous salt, an acid, hydrogen peroxide with simultaneous injection of the oxygen-containing gas, followed by addition of alkali hydroxide and hydrogen peroxide with simultaneous injection of the oxygen-containing gas.

12. The method according to claim 9, wherein the groundwater is contaminated with one or more pollutants selected from the group consisting of polychlorinated hydrocarbons, polycyclic aromatic hydrocarbons, polychlorinated biphenyls, chlorinated solvents, pharmaceutical leftovers, petroleum products such as petroleum, gasoline, crude oil, diesel fuel, aviation fuel, jet fuel, kerosene, liquefied petroleum gases, petrochemical feedstocks and any mixture thereof.

13. The method according to claim 12, wherein the groundwater is polluted with one or more pollutants selected from the group consisting of chlorinated solvents, diesel fuel and crude oil.

14. The method according to claim 3, wherein the injection of the oxygen-containing gas to the soil starts simultaneously with, or after, the addition of the hydrogen peroxide stream.

15. The method according to claim 3, wherein the soil is contaminated with one or more pollutants selected from the group consisting of polychlorinated hydrocarbons, polycyclic aromatic hydrocarbons, polychlorinated biphenyls, chlorinated solvents, pharmaceutical leftovers, petroleum products such as petroleum, gasoline, crude oil, diesel fuel, aviation fuel, jet fuel, kerosene, liquefied petroleum gases, petrochemical feedstocks and any mixture thereof.

16. The method according to claim 4, wherein the soil is contaminated with one or more pollutants selected from the group consisting of polychlorinated hydrocarbons, polycyclic aromatic hydrocarbons, polychlorinated biphenyls, chlorinated solvents, pharmaceutical leftovers, petroleum products such as petroleum, gasoline, crude oil, diesel fuel, aviation fuel, jet fuel, kerosene, liquefied petroleum gases, petrochemical feedstocks and any mixture thereof.

17. The method according to claim 5, wherein the soil is contaminated with one or more pollutants selected from the group consisting of polychlorinated hydrocarbons, polycyclic aromatic hydrocarbons, polychlorinated biphenyls, chlorinated solvents, pharmaceutical leftovers, petroleum products such as petroleum, gasoline, crude oil, diesel fuel, aviation fuel, jet fuel, kerosene, liquefied petroleum gases, petrochemical feedstocks and any mixture thereof.

18. The method according to claim 6, wherein the soil is contaminated with one or more pollutants selected from the group consisting of polychlorinated hydrocarbons, polycyclic aromatic hydrocarbons, polychlorinated biphenyls, chlorinated solvents, pharmaceutical leftovers, petroleum products such as petroleum, gasoline, crude oil, diesel fuel, aviation fuel, jet fuel, kerosene, liquefied petroleum gases, petrochemical feedstocks and any mixture thereof.
